(19) United States
(12) Patent Application Publication
(10) Pub. No.: US 2023/0334062 A1
(43) Pub. Date: Oct. 19, 2023

(54) COMPUTER-READABLE RECORDING MEDIUM STORING CORRELATION COEFFICIENT COMPUTATION PROGRAM, INFORMATION PROCESSING DEVICE, AND CORRELATION COEFFICIENT COMPUTATION METHOD

(71) Applicant: Fujitsu Limited, Kawasaki-shi (JP)

(72) Inventor: Kazuhito MATSUDA, Kawasaki (JP)

(73) Assignee: Fujitsu Limited, Kawasaki-shi (JP)

(21) Appl. No.: 18/162,125

(22) Filed: Jan. 31, 2023

(30) Foreign Application Priority Data
Apr. 13, 2022 (JP) 2022-066461

(51) Int. Cl. G06F 16/25; G06F 16/22

(52) U.S. Cl. CPC G06F 16/254; G06F 16/221

(57) ABSTRACT

A process includes obtaining first and third average-values of remaining elements after masking, with a first condition, first and second column-data obtained by taking out values of first and second attributes from tabular-data, obtaining second and fourth average-values of the remaining elements after masking the first and second column-data with a second condition that negates the first condition, loading the first and second column-data into a first register, loading values obtained by masking the first and third average-values with the first condition and values obtained by masking the second and fourth average-values with the second condition, into a second register, obtaining first and second value-sequences by performing first and second subtraction between value-sequences loaded into each of the first and second registers on the first and second column-data, and obtaining correlation-coefficients between the first and second column-data for the first and second conditions, based on the first and second value-sequences.

### CROSS-REFERENCE TO RELATED APPLICATION

This application is based upon and claims the benefit of priority of the prior Japanese Patent Application No. 2022-66461, filed on Apr. 13, 2022, the entire contents of which are incorporated herein by reference.

### FIELD

The embodiments discussed herein are related to a correlation coefficient computation program and the like.

### BACKGROUND

In recent years, research has been conducted to efficiently narrow down the number of conditions to be causally searched, by extracting correlated conditions. FIG. 17 is a reference diagram illustrating condition extraction for statistical causal search. As illustrated in FIG. 17, such a technique extracts all condition candidates for correlated data from past data for artificial intelligence (AI) to train. Then, in this technique, all conditions for data having a causal relationship are extracted from the extracted condition candidates for the data. However, in this technique, while all the condition candidates for the data are searched for a causal relationship, there is a problem that the search is unrealistic from the viewpoint of the amount of computation.

Thus, a technique that efficiently narrows down the number of conditions to be causally searched, by relaxing the condition search target to the correlation from the causal relationship has been disclosed. FIG. 18 is a reference diagram illustrating a technique for discovering individual characteristic causal relationships. As illustrated in FIG. 18, this technique first uses an emerging pattern discovery technique to exhaustively find, from a past sample set, a combination of an important factor candidate that has a strong correlation with the objective variable under a specified condition, and the condition at that time. Note that the past sample set is used after being binarized based on a threshold value.

Thereafter, for each of the found conditions, a causal search technique is used to determine whether the important factor candidate under that condition is accurately an important factor. For example, a case where there is “x1∧x3∧x4→y” (y=1 when x1=x3=x4=1 is true) is assumed. In such a case, one variable chosen from the left side is assigned as an “important factor candidate” and the rest is assigned as a “condition”. Here, it is assumed that x4 indicates the “important factor candidate” and the remaining “x1∧x3” indicates the “condition”. In this technique, if there is a high correlation between the “important factor candidate” and y on the right side in the past sample set that satisfies the “condition”, that “condition” is adopted. The conditions and important factors found in this manner are held in a database (DB). Then, when applied, for samples whose causal relationships are desired, the conditions that these samples satisfy are selected from the DB, and the corresponding important factors are presented.

Here, a technique that converts two types of signals to be correlated into a 1-bit signal according to whether or not the signals are less than an intermediate value of the dynamic range to reduce the arithmetic amount relating to correlation arithmetic operations has been disclosed.

Japanese Laid-open Patent Publication No. 2008-158855 and Yusuke Koyanagi, four others, “Developing a Framework for Individual Causal Discovery and its Application to Real Marketing Data”, The Japanese Society for Artificial Intelligence 18th Special Interest Group on Business Informatics, March 2021, <URL:http://sig-bi.jp/doc/18thSIG-BI2021/18thSIG-BI2021 paper13.pdf> are disclosed as related art.

### SUMMARY

According to an aspect of the embodiments, a non-transitory computer-readable recording medium storing a correlation coefficient computation program for causing a computer to execute a process, the process includes obtaining a first average value of remaining elements after masking, with a first condition, first column data obtained by taking out values of a first attribute from tabular data in which values of a plurality of attributes that each sample includes are accumulated for each sample, obtaining a second average value of the remaining elements after masking the first column data with a second condition that negates the first condition, loading the first column data into a first register, loading values obtained by masking the first average value with the first condition and values obtained by masking the second average value with the second condition, into a second register, obtaining a first value sequence by performing first subtraction between value sequences loaded into the first register and value sequences loaded into the second register on the first column data, obtaining a third average value of remaining elements after masking, with a first condition, second column data obtained by taking out values of a second attribute from tabular data in which values of a plurality of attributes that each sample includes are accumulated for each sample, obtaining a fourth average value of the remaining elements after masking the second column data with the second condition that negates the first condition, loading the second column data into a first register, loading values obtained by masking the third average value with the first condition and values obtained by masking the forth average value with the second condition, into a second register, obtaining a second value sequence by performing second subtraction between value sequences loaded into the first register and value sequences loaded into the second register, and obtaining correlation coefficients between the first column data and the second column data for the first condition and the second condition, based on the first value sequence and the second value sequence, by using arithmetic logical units with the first register and the second register as inputs.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a configuration of an information processing device according to an embodiment;

FIG. 2 is a diagram illustrating an example of an observed value list;

FIG. 3 is a diagram illustrating an example of a condition list;

FIG. 4A is a diagram (1) illustrating the principle of an arithmetic method according to the embodiment;

FIG. 4B is a diagram (2) illustrating the principle of the arithmetic method according to the embodiment;

FIG. 5 is a diagram illustrating an average value computation method according to the embodiment;

FIG. 6 is a diagram illustrating a deviation computation method according to the embodiment;

FIG. 7A is a diagram (1) illustrating a correlation coefficient computation method according to the embodiment;

FIG. 7B is a diagram (2) illustrating the correlation coefficient computation method according to the embodiment;

FIG. 8A is a diagram (1) illustrating an example of the flow of a correlation coefficient computation process according to the embodiment;

FIG. 8B is a diagram (2) illustrating an example of the flow of the correlation coefficient computation process according to the embodiment;

FIG. 8C is a diagram (3) illustrating an example of the flow of the correlation coefficient computation process according to the embodiment;

FIG. 8D is a diagram (4) illustrating an example of the flow of the correlation coefficient computation process according to the embodiment;

FIG. 8E is a diagram (5) illustrating an example of the flow of the correlation coefficient computation process according to the embodiment;

FIG. 8F is a diagram (6) illustrating an example of the flow of the correlation coefficient computation process according to the embodiment;

FIG. 9 is a diagram illustrating an example of the flowchart of the entire correlation coefficient computation process according to the embodiment;

FIG. 10 is a diagram illustrating an example of the flowchart of an average value computation process according to the embodiment;

FIG. 11 is a diagram illustrating an example of the flowchart of a deviation computation process according to the embodiment;

FIG. 12 is a diagram illustrating an example of the flowchart of a correlation coefficient computation and determination process according to the embodiment;

FIG. 13 is a diagram illustrating an example of a computer that executes an information processing program;

FIG. 14A is a reference diagram (1) explaining condition enumeration for extracting a correlated sample group;

FIG. 14B is a reference diagram (2) explaining condition enumeration for extracting a correlated sample group;

FIG. 14C is a reference diagram (3) explaining condition enumeration for extracting a correlated sample group;

FIG. 15 is a reference diagram explaining correlation coefficient operations for observed values;

FIG. 16 is a reference diagram explaining correlation coefficient operations using single instruction multiple data (SIMD) registers and a predicate register;

FIG. 17 is a reference diagram illustrating condition extraction for statistical causal search; and

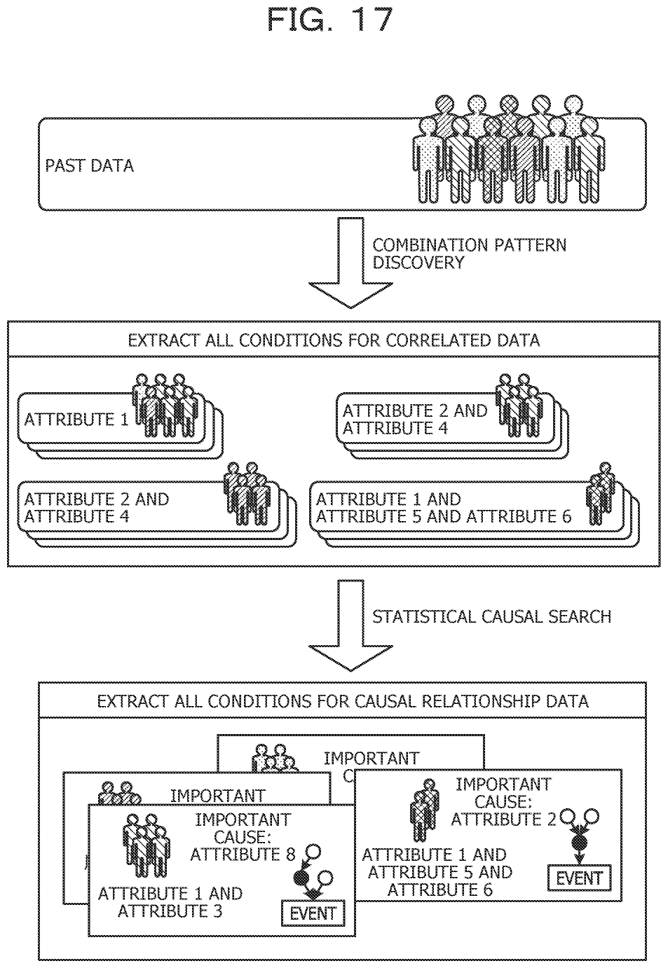

FIG. 18 is a reference diagram illustrating a technique for discovering individual characteristic causal relationships.

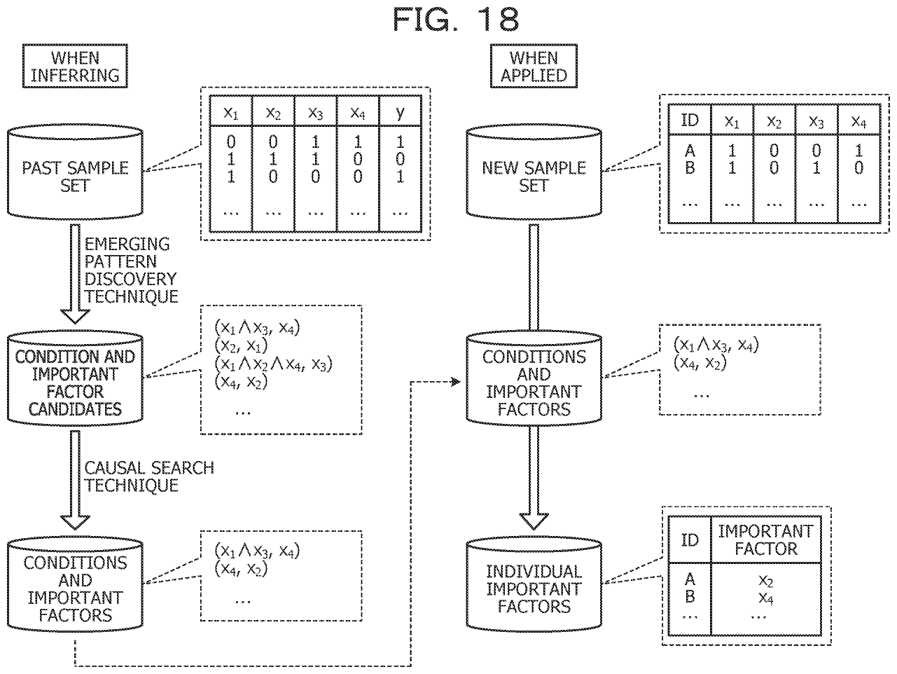

### DESCRIPTION OF EMBODIMENTS

While a correlation coefficient is calculated between the “important factor candidate” and y on the right side when the condition for extracting the past sample set is adopted, it is desirable to calculate the correlation coefficient efficiently.

Hereinafter, embodiments of techniques capable to efficiently calculate a correlation coefficient to be used when adopting a condition under which correlation appears will be described in detail with reference to the drawings. Note that the present embodiments are not limited to the embodiments.

### Embodiments

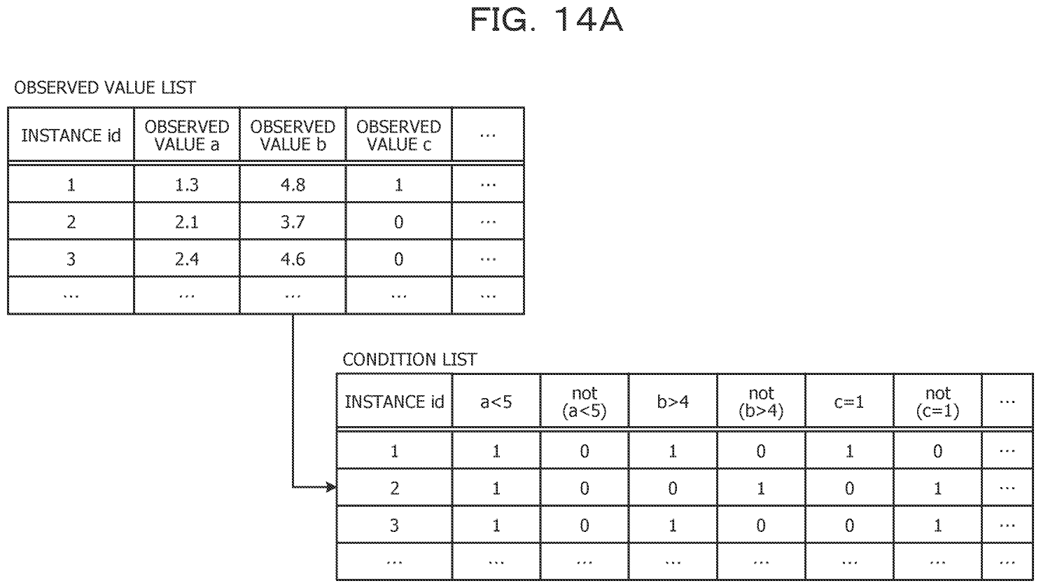

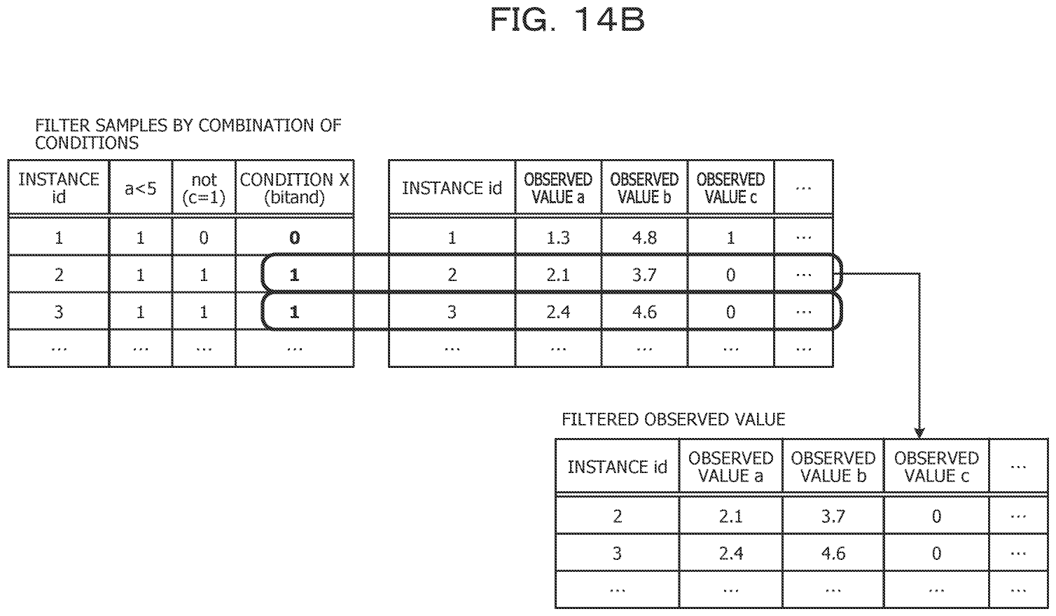

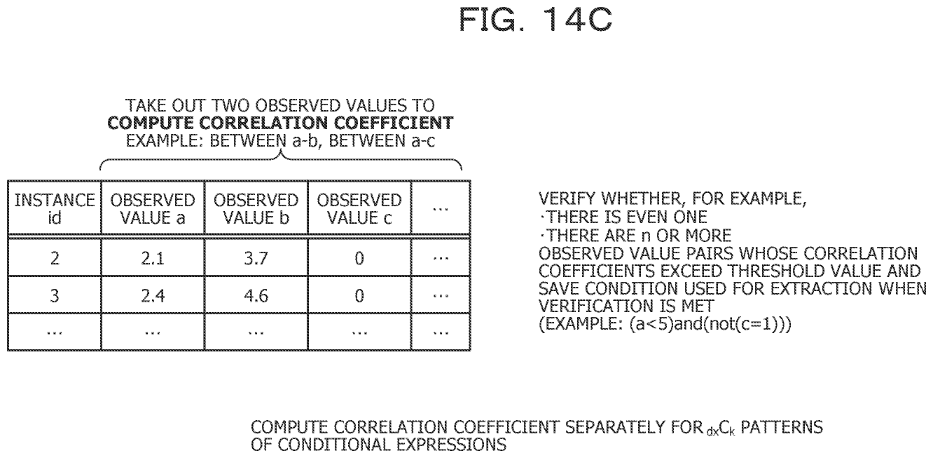

First, enumerating conditions for extracting a sample set “having correlated observed value pairs”, from a numerical data group for a plurality of events observed with respect to individual instances will be considered. FIGS. 14A to 14C are reference diagrams explaining condition enumeration for extracting a correlated sample group.

The left diagram of FIG. 14A represents an observed value list. The observed value list is a list that stores a numerical data group of a plurality of observed values (attributes) observed for an instance id. The right diagram of FIG. 14A represents a condition list. The condition list is a list of condition candidates for extracting a sample set “having correlated observed value pairs”. Conditions are generated from, for example, the observed values but are not limited to this. Since the conditions are intended for an exhaustive search, a not condition is included for every single condition. Here, when the single condition is “a<5”, “not(a<5)” is stored as the not condition.

As illustrated in FIG. 14B, a conditional expression X is created by taking out k conditions from among all the conditions. Here, the conditional expression X is “(a<5) and not(c=1)” indicating the logical product of “a<5” and “not(c=1)”. In the condition enumeration process, the logical product is computed from the condition list, using the conditional expression X, and samples are filtered. A filtered observed value list is represented in the lower right of FIG. 14B. For example, a sample set in which the result of computing the logical product using the conditional expression X indicates “1” is represented.

FIG. 14C represents the observed value list filtered by the conditional expression X. This observed value list is the same as the observed value list in the lower right diagram of FIG. 14B. The condition enumeration process takes out two observed values from the filtered observed value list and computes the correlation coefficient for the taken-out observed value pair. For example, observed values a and b are taken out, and the correlation coefficient between the observed values a-b is computed. The observed values a and c are taken out, and the correlation coefficient between the observed values a-c is computed. The observed values b and c are taken out, and the correlation coefficient between the observed values b-c is computed. Then, the condition enumeration process determines that, for example, there are n or more observed value pairs whose correlation coefficients exceed a threshold value and enumerates the conditions used for filtering when the determination is met. Here, one condition enumerated is “(a<5) and not(c=1)”.

When conditions are exhaustively searched, _{dx}Cₖ patterns of conditional expressions will be determined for the total number of conditions dx and the number of conditions k to be taken out. For example, it is determined individually whether or not each conditional expression is a condition for extracting the sample set “having correlated observed value pairs”.

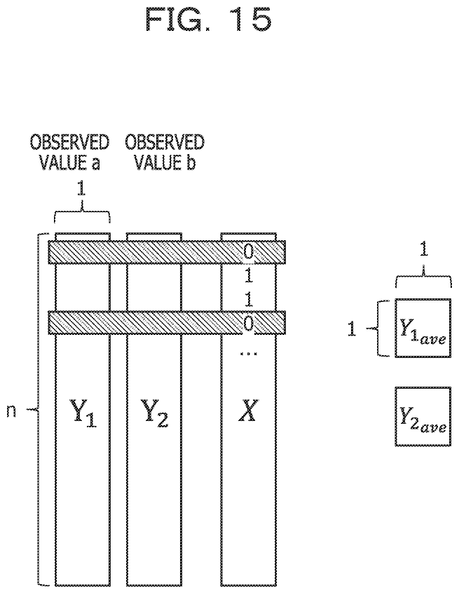

FIG. 15 is a reference diagram explaining correlation coefficient operations for observed values. As illustrated in FIG. 15, the correlation coefficient operation process uses following expressions (1) to (4) with respect to matrices Y1 and Y2 obtained by taking out two observed values from the observed value list filtered by a condition X, to find a correlation coefficient R_{Y12}. Note that Y₁ₐᵥₑ indicated in expressions (1) and (2) denotes the average value of the matrix Y1. The average value of the matrix Y2 is denoted by Y₂ₐᵥₑ.

$${S}_{{y}_{12}} = ( {Y}_{1} - {Y}_{{1}_{ave}} ) \times ( {Y}_{2} - {Y}_{{2}_{ave}} ) \qquad Expression ( 1 )$$

$${S}_{{y}_{1}} = {( {Y}_{1} - {Y}_{{1}_{ave}} )}^{2} \qquad Expression ( 2 )$$

$${S}_{{y}_{2}} = {( {Y}_{2} - {Y}_{{2}_{ave}} )}^{2} \qquad Expression ( 3 )$$

$${R}_{{y}_{12}} = \frac{\vert {sumS}_{{y}_{12}} \vert}{\sqrt{{sumS}_{{y}_{1}}} \times \sqrt{{sumS}_{{y}_{2}}}} \qquad Expression ( 4 )$$

For example, the correlation coefficient operation process masks the matrices Y1 and Y2 with the condition X and computes the correlation coefficients only with the remaining elements (the elements in the rows having one in the X matrix).

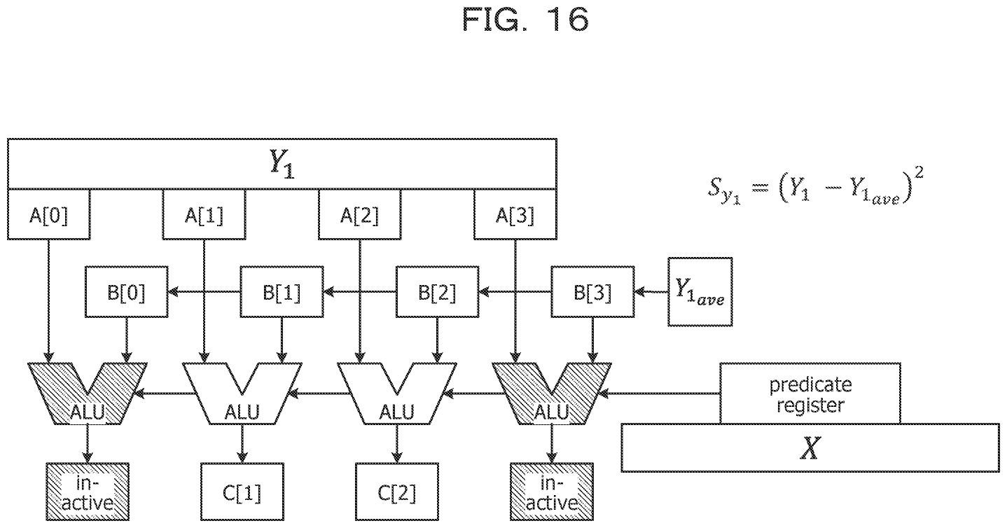

Incidentally, the scalable vector extension (SVE) of ARM Ltd. is capable of controlling whether or not the operation is made effective, according to the bit string input to the predicate register. FIG. 16 is a reference diagram explaining correlation coefficient operations using SIMD registers and a predicate register. Note that, here, the operation of expression (2) among the correlation coefficient operations will be described.

The correlation coefficient operation process loads the matrix Y1 into a SIMD register a, loads the average value Y₁ₐᵥₑ into a SIMD register b, and gives the X matrix to the predicate register. Then, since arithmetic logical units (ALUs) are masked by the X matrix given to the predicate register, the correlation coefficient operation process is allowed to conduct SIMD computation without generating filtered Y illustrated in the lower right of FIG. 14B. Here, when the X matrix is “0110”, the ALUs for the first and fourth bits become inactive, and expression (2) is not computed. Then, the ALUs for the second and third bits become active, and expression (2) is computed.

However, since the correlation coefficient operation process is not allowed to effectively utilize the ALUs in the portion masked by the predicate register, there is a problem that the central processing unit (CPU) utilization rate decreases. Thus, in the embodiment, a correlation coefficient operation process capable of effectively utilizing the ALUs will be described.

[Configuration of Information Processing Device]

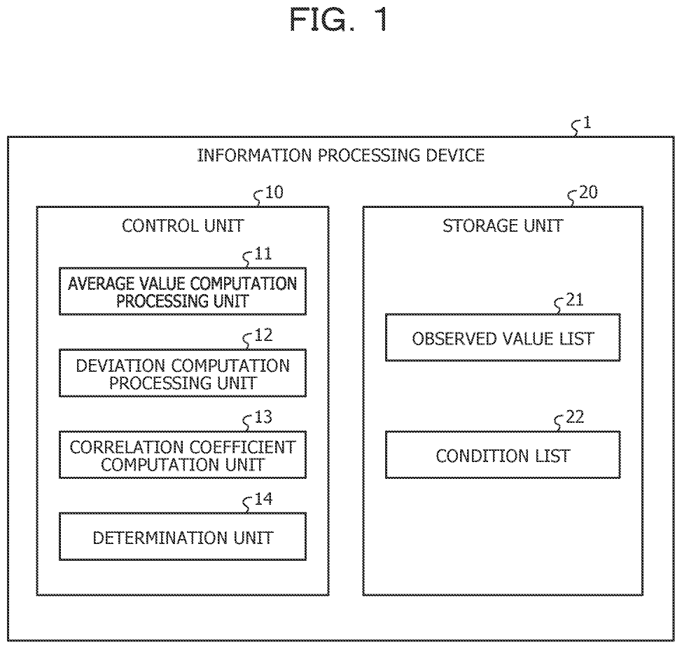

FIG. 1 is a functional block diagram illustrating a configuration of the information processing device according to the embodiment.

The information processing device 1 includes a control unit 10 and a storage unit 20. The control unit 10 includes an average value computation processing unit 11, a deviation computation processing unit 12, a correlation coefficient computation unit 13, and a determination unit 14. The storage unit 20 includes an observed value list 21 and a condition list 22.

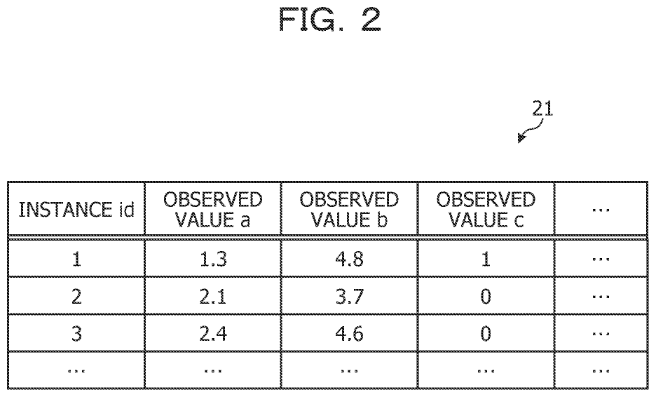

The observed value list 21 is a list that stores a numerical data group of a plurality of observed values observed for an instance id. For example, the observed value list 21 is tabular data in which the values of a plurality of observed values (attributes) that each instance id has are accumulated. The instance id mentioned here refers to an identifier that uniquely identifies an individual person or the like. Each column of the observed value list 21 corresponds to one of the observed values (attributes). Here, an example of the observed value list 21 will be described with reference to FIG. 2.

FIG. 2 is a diagram illustrating an example of the observed value list. As illustrated in FIG. 2, the observed value list 21 is a list that associates the instance id, an observed value a, an observed value b, an observed value c, . . . with each other. As an example, when the instance id is “1”, “1.3” is stored as the observed value a, “4.8” is stored as the observed value b, and “1” is stored as the observed value c. When the instance id is “2”, “2.1” is stored as the observed value a, “3.7” is stored as the observed value b, and “0” is stored as the observed value c.

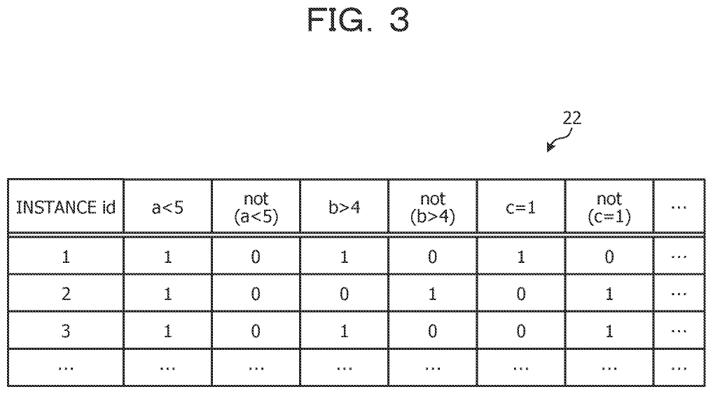

Returning to FIG. 1, the condition list 22 is a list of condition candidates for extracting a sample set of the instances id having “correlated observed value pairs”. For example, the condition list 22 is tabular data obtained from the observed value list 21 by binarizing the values of a plurality of observed values (attributes) that each instance id has, based on the condition candidates. For example, the column-wise arrays of the condition list 22 form bit strings for the conditions. The conditions are generated from, for example, the observed values but are not limited to this. In addition, since the conditions are intended for an exhaustive search, a not condition is included for every single condition. Here, an example of the condition list 22 will be described with reference to FIG. 3.

FIG. 3 is a diagram illustrating an example of the condition list. The condition list 22 is a list that associates the instances id and various conditions with each other. As an example of the conditions, “a<5”, “b>4”, and “c=1” are stored. Then, for these conditions, “not(a<5)”, “not(b>4)”, and “not(c=1)” are stored as the not conditions. The condition “a<5” indicates a condition that the observed value a is less than “5”. The condition “not(a<5)” indicates the negative condition of the condition that the observed value a is less than “5”, for example, the condition that the observed value a is equal to or more than “5”.

Then, separately for various conditions, “1” is set when the conditions are satisfied, and “0” is set when the conditions are not satisfied. As an example of the values, when the instance id is “1”, the observed value a is “1.3” for the condition “a<5”, and “1” is set because the observed value a is less than “5”. As for the condition “not(a<5)”, the observed value a is “1.3”, and “0” is set because the observed value a is less than “5”. Then, the column-wise array for the condition “a<5” forms a bit string of “111 . . . ”. The column-wise array for the condition “not(a<5)” forms a bit string of “000 . . . ”.

Returning to FIG. 1, the information processing device 1 enumerates conditions for extracting a sample set of the instances id “having correlated observed value pairs”, from the numerical data group in the observed value list 21. When searching conditions, the information processing device 1 utilizes including the negative condition paired with a certain condition into a plurality of conditions to be searched, to perform operations of the correlation coefficients collectively for the certain condition and the negative condition of the certain condition.

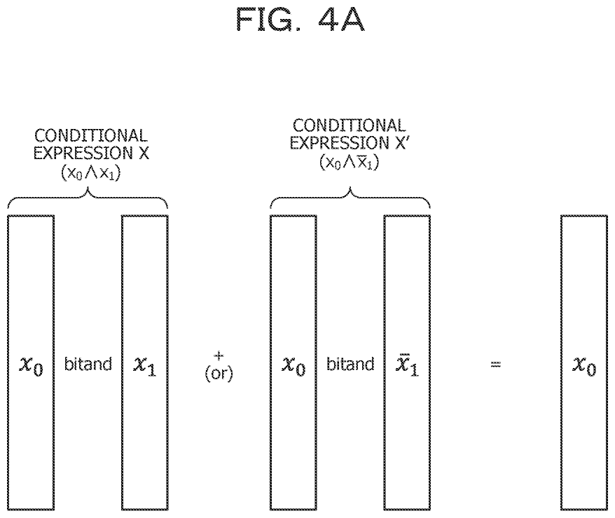

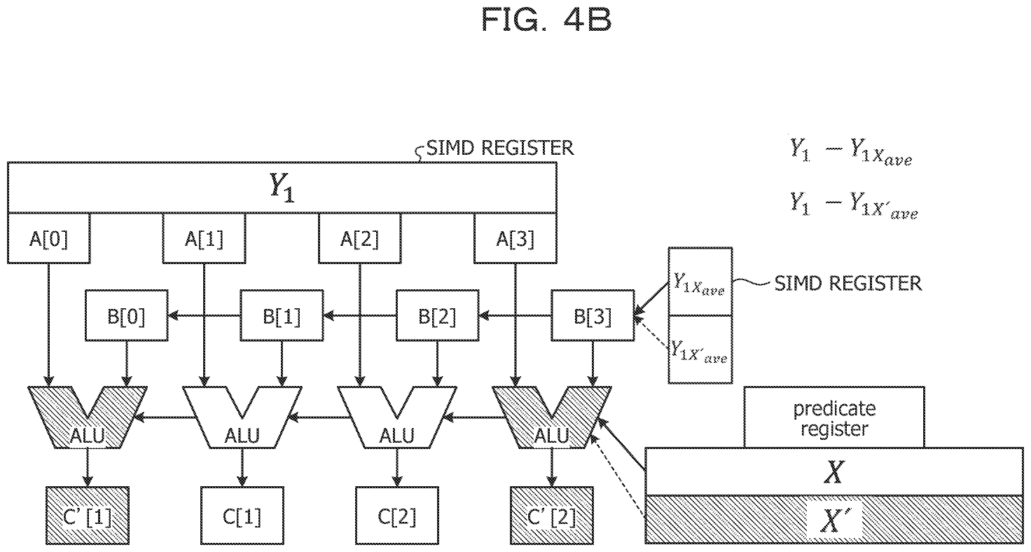

Here, the principle of the arithmetic method for the correlation coefficient will be described with reference to FIGS. 4A and 4B. FIGS. 4A and 4B are diagrams illustrating the principle of the arithmetic method according to the embodiment. As illustrated in FIG. 4A, regular inclusion of the negative condition of a condition x₁ for the condition x₁ is utilized. For example, when a certain conditional expression X is (x₀∧x₁), a conditional expression X′ (x₀∧not(x₁)) obtained by replacing x₁ with the negative condition of x₁ is also included for the certain conditional expression X as a condition to be determined. In consequence, the bit string corresponding to the conditional expression X and the bit string corresponding to the conditional expression X′ form exclusive bit strings with the condition x₀ as the axis.

For example, the bit string corresponding to the conditional expression X is computed by bitand (logical product) between the bit string corresponding to the condition x₀ and the bit string corresponding to the condition x₁. Meanwhile, the bit string corresponding to the conditional expression X′ is computed by bitand (logical product) between the bit string corresponding to the condition x₀ and the bit string corresponding to the condition not(x₁). The logical sum of the bit string corresponding to the conditional expression X and the bit string corresponding to the conditional expression X′ forms the bit string corresponding to the condition x₀. Therefore, the conditional expressions X and X′ can be collectively determined because the conditional expressions X and X′ are conditional expressions that share the condition x₀ but do not overlap.

FIG. 4B represents a schematic diagram of executing deviation computation included in expression (2) using the SIMD registers and the predicate register. Here, it is assumed that the conditional expression X has “0110” and the conditional expression X′ has “1001”. As illustrated in FIG. 4B, since the arithmetic logical units (ALUs) are masked by the bit string corresponding to the conditional expression X given to the predicate register, the ALUs corresponding to the unmasked bits of the average value Y_{1X′ave} loaded into the SIMD register are activated, and the results are calculated in C′[1] and C′[2]. In addition, since the arithmetic logical units (ALUs) are masked by the bit string of the conditional expression X′ given to the predicate register, the ALUs corresponding to the unmasked bits of the average value Y_{1X′ave} loaded into the SIMD register are activated, and the results are calculated in C′[1] and C′[2]. In this manner, since the bit string corresponding to conditional expression X and the bit string corresponding to conditional expression X′ form exclusive bit strings with the condition x₀ as the axis, the conditional expressions X and X′ can be collectively determined.

Returning to FIG. 1, with respect to the matrix Y1 obtained by taking out one observed value from the observed value list 21, the average value computation processing unit 11 uses the predicate register and the SIMD registers to compute the average value of the remaining elements after masking with the conditional expression X (=x₀∧x₁). In addition, with respect to the same matrix Y1, the average value computation processing unit 11 uses the predicate register and the SIMD registers to compute the average value of the remaining elements after masking with the conditional expression X′ (=x₀∧not(x₁)). The conditional expression X′ is a conditional expression that negates the conditional expression X.

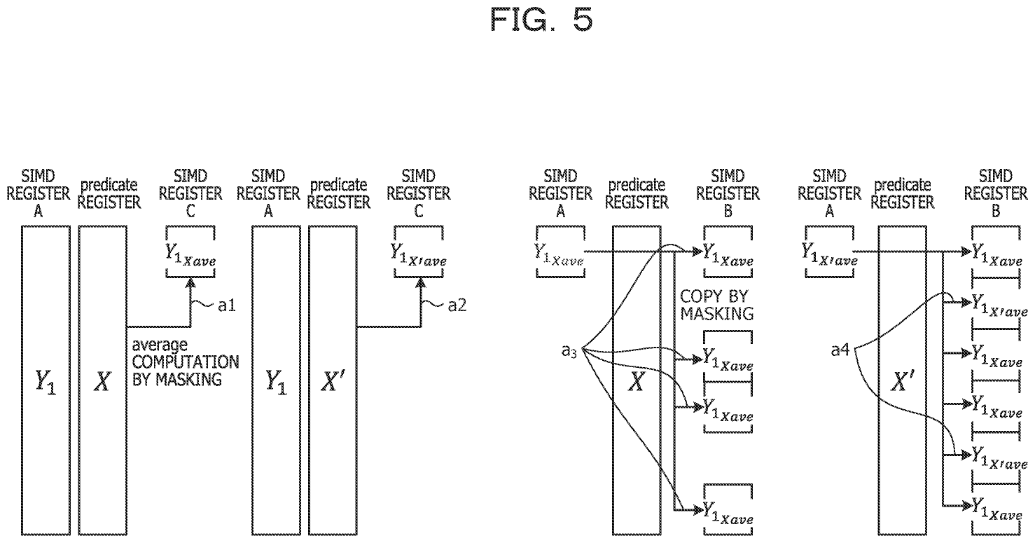

Here, an average value computation method performed by the average value computation processing unit 11 will be described with reference to FIG. 5. FIG. 5 is a diagram illustrating the average value computation method according to the embodiment.

As illustrated in FIG. 5, the average value computation processing unit 11 loads the matrix Y1 obtained by taking out the values of first observed values from the observed value list 21, into a SIMD register A. The average value computation processing unit 11 loads a first bit string obtained by binarizing the elements of the matrix Y1 with the conditional expression X, into the predicate register. Then, the average value computation processing unit 11 masks the arithmetic logical units (ALUs) with the predicate register to calculate a first average value Y1_{Xave} of the elements of the SIMD register A (reference sign a1). For example, the average value computation processing unit 11 calculates the first average value Y1_{Xave} of the remaining elements after masking the elements of the SIMD register A with the predicate register.

In addition, the average value computation processing unit 11 loads the elements of the matrix Y1 obtained by taking out the values of the first observed values from the observed value list 21, into the SIMD register A. The average value computation processing unit 11 loads a second bit string obtained by binarizing the elements of the matrix Y1 with the conditional expression X′, into the predicate register. Then, the average value computation processing unit 11 masks the arithmetic logical units (ALUs) with the predicate register to calculate a second average value Y1_{X′ave} of the elements of the SIMD register A (reference sign a2). For example, the average value computation processing unit 11 calculates the second average value Y1_{X′ave} of the remaining elements after masking the elements of the SIMD register A with the predicate register.

In addition, the average value computation processing unit 11 loads the first bit string binarized by the conditional expression X into the predicate register. The average value computation processing unit 11 loads the first average value Y1_{Xave} into the SIMD register A. Then, the average value computation processing unit 11 copies the first average value Y1_{Xave} to a SIMD register B by masking with the predicate register (reference sign a3). In addition, the average value computation processing unit 11 loads the second bit string binarized by the conditional expression X′ into the predicate register. The average value computation processing unit 11 loads the second average value Y1_{X′ave} into the SIMD register A. Then, the average value computation processing unit 11 copies the second average value Y1_{X′ave} to the SIMD register B by masking with the predicate register (reference sign a4). Since the first bit string binarized by the conditional expression X and the second bit string binarized by the conditional expression X′ form exclusive bit strings with the common condition x₀ as the axis, the first average value Y1_{Xave} and the second average value Y1_{X′ave} copied to the SIMD register B are not copied to the same bit. Therefore, the average value computation processing unit 11 is allowed to load the average values Y1_{Xave} and Y1_{X′ave} of the first observed values masked by the conditional expressions X and X′, respectively, into the SIMD register B, using the predicate register.

In addition, with respect to the matrix Y2 obtained by taking out second observed values from the observed value list 21, as in the case of the matrix Y1, the average value computation processing unit 11 only has to calculate an average value Y2_{Xave} of the remaining elements after masking with the conditional expression X (=x₀∧x₁). Furthermore, with respect to the same matrix Y2, the average value computation processing unit 11 only has to calculate an average value Y2_{X′ave} of the remaining elements after masking with the conditional expression X′ (=x₀∧not(x₁)), as in the case of the matrix Y1. Then, the average value computation processing unit 11 only has to load the average values Y2_{Xave} and Y2_{X′ave} of the second observed values masked by the conditional expressions X and X′, respectively, into the SIMD register B, using the predicate register.

Returning to FIG. 1, the deviation computation processing unit 12 uses the predicate register and the SIMD registers to compute the deviation between the matrix Y1 obtained by taking out the first observed values from the observed value list 21, and the column of the average values obtained by being masked separately by the conditional expressions X and X′.

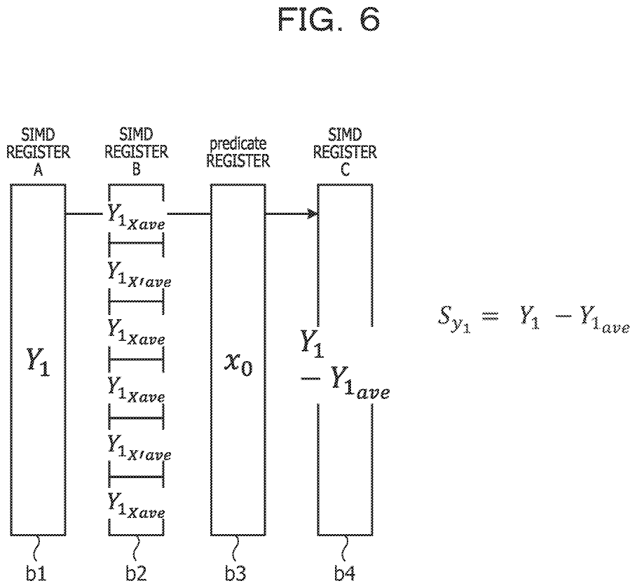

Here, a deviation computation method performed by the deviation computation processing unit 12 will be described with reference to FIG. 6. FIG. 6 is a diagram illustrating the deviation computation method according to the embodiment.

As illustrated in FIG. 6, the SIMD register B is set with the column of the average values (Y1_{Xave} and Y1_{X′ave}) masked by the conditional expressions X and X′, respectively, by the average value computation processing unit 11 (reference sign b2). In addition, the SIMD register A is set with the elements of the matrix Y1 obtained by taking out the values of the first observed values (reference sign b1). The deviation computation processing unit 12 loads the condition x₀ common to the conditional expressions X and X′ into the predicate register (reference sign b3). Then, the deviation computation processing unit 12 masks the arithmetic logical units (ALUs) with the predicate register to execute an operation of subtracting the SIMD register B from the SIMD register A. Then, the deviation computation processing unit 12 loads the subtraction result into a SIMD register C (reference sign b4). As a result, the deviation computation processing unit 12 is allowed to compute “Y1−Y1ₐᵥₑ” for the conditional expressions X and X′.

In addition, also for the matrix Y2 obtained by taking out the second observed values from the observed value list 21, the deviation computation processing unit 12 only has to compute “Y2−Y2ₐᵥₑ” for the conditional expressions X and X′, as in the case of the matrix Y1. In this manner, the deviation computation processing unit 12 is allowed to perform the deviation computation collectively for the conditional expressions X and X′, by loading the condition x₀ common to the conditional expressions X and X′ into the predicate register and performing the computation.

The correlation coefficient computation unit 13 uses the predicate register and the SIMD registers to collectively compute the correlation coefficient for the conditional expression X between the matrix Y1 of the first observed values and the matrix Y2 of the second observed values, and the correlation coefficient for the conditional expression X′ between the matrices Y1 and Y2.

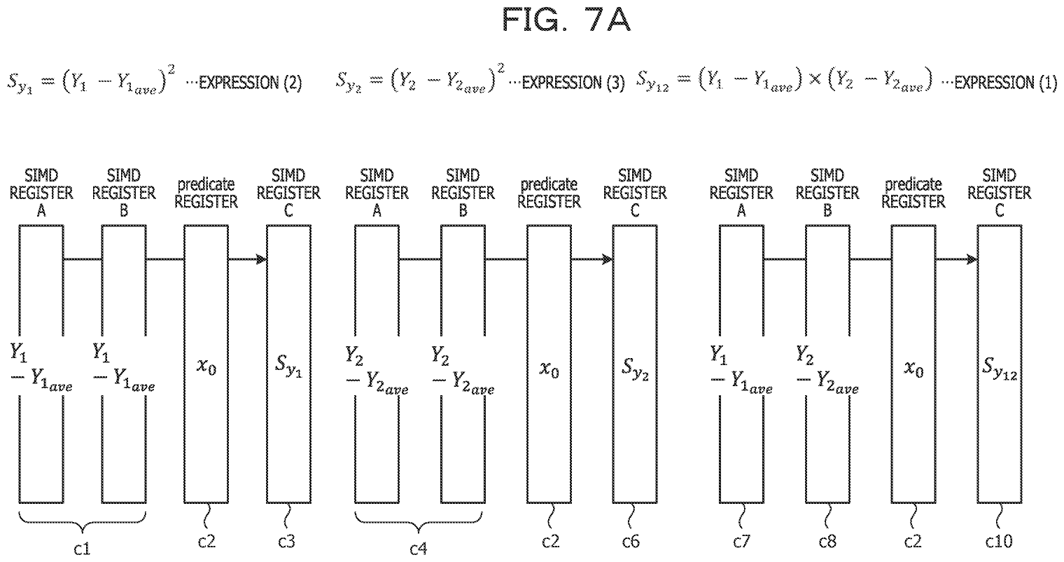

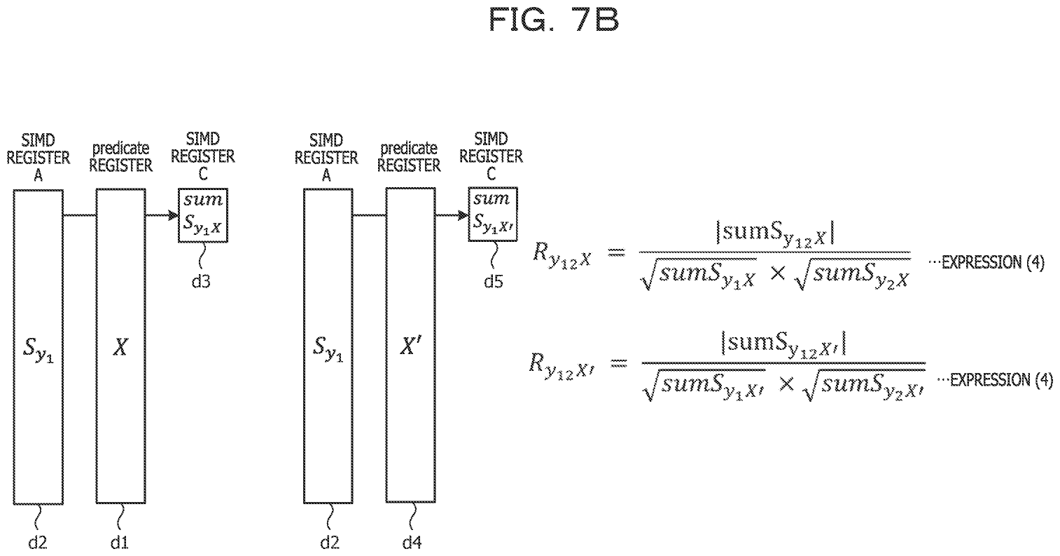

Here, a correlation coefficient computation method performed by the correlation coefficient computation unit 13 will be described with reference to FIGS. 7A and 7B. FIGS. 7A and 7B are diagrams illustrating the correlation coefficient computation method according to the embodiment.

As illustrated in FIG. 7A, for the matrix Y1 of the first observed values, the correlation coefficient computation unit 13 loads the column values of “Y1−Y1ₐᵥₑ” for the conditional expressions X and X′ processed by the deviation computation processing unit 12, into the SIMD registers A and B (reference sign c1). The correlation coefficient computation unit 13 loads the condition x₀ common to the conditional expressions X and X′ into the predicate register (reference sign c2). Then, the correlation coefficient computation unit 13 masks the arithmetic logical units (ALUs) with the predicate register to execute an operation of multiplying the SIMD registers A and B. Then, the correlation coefficient computation unit 13 loads the multiplication result into the SIMD register C (reference sign c3). As a result, for the matrix Y1 of the first observed values, the correlation coefficient computation unit 13 computes expression (2) collectively for the conditional expressions X and X′ to find S_{y1}.

In addition, for the matrix Y2 of the second observed values, the correlation coefficient computation unit 13 loads the column values of “Y2−Y2ₐᵥₑ” for the conditional expressions X and X′ processed by the deviation computation processing unit 12, into the SIMD registers A and B (reference sign c4). Then, the correlation coefficient computation unit 13 masks the arithmetic logical units (ALUs) with the predicate register to execute an operation of multiplying the SIMD registers A and B. Then, the correlation coefficient computation unit 13 loads the multiplication result into the SIMD register C (reference sign c6). As a result, for the matrix Y2 of the second observed values, the correlation coefficient computation unit 13 computes expression (3) collectively for the conditional expressions X and X′ to find S_{y2}.

In addition, for the matrix Y1 of the first observed values, the correlation coefficient computation unit 13 loads the column values of “Y1−Y1ₐᵥₑ” for the conditional expressions X and X′ into the SIMD register A (reference sign c7). For the matrix Y2 of the second observed values, the correlation coefficient computation unit 13 loads the column values of “Y2−Y2ₐᵥₑ” for the conditional expressions X and X′ into the SIMD register B (reference sign c8). Then, the correlation coefficient computation unit 13 masks the arithmetic logical units (ALUs) with the predicate register to execute an operation of multiplying the SIMD registers A and B. Then, the correlation coefficient computation unit 13 loads the multiplication result into the SIMD register C (reference sign c10). As a result, for the matrix Y1 of the first observed values and the matrix Y2 of the second observed values, the correlation coefficient computation unit 13 computes expression (1) collectively for the conditional expressions X and X′ to find S_{y12}.

As illustrated in FIG. 7B, the correlation coefficient computation unit 13 uses the predicate register to split the results of the collective computation for the conditional expressions X and X′.

For example, the correlation coefficient computation unit 13 loads the first bit string obtained by binarizing the elements of the matrix Y1 with the conditional expression X, into the predicate register (reference sign d1). The correlation coefficient computation unit 13 loads S_{y1} for the conditional expressions X and X′ computed by expression (2), into the SIMD register A (reference sign d2). Then, the correlation coefficient computation unit 13 masks the SIMD register A with the predicate register and computes the sum (sum) of the unmasked elements to find “sumS_{y1X}” (reference sign d3).

Then, the correlation coefficient computation unit 13 loads the second bit string obtained by binarizing the elements of the matrix Y1 with the conditional expression X′, into the predicate register (reference sign d4). Then, the correlation coefficient computation unit 13 masks the SIMD register A with the predicate register and computes the sum (sum) of the unmasked elements to find “sumS_{y1X′}” (reference sign d5).

In addition, similarly, the correlation coefficient computation unit 13 finds “sumS_{y2X}” and “sumS_{y2X′}” from S_{y2} for the conditional expressions X and X′ computed by expression (2). Similarly, the correlation coefficient computation unit 13 finds “sumS_{y12X}” and “sumS_{y12X′}” from S_{y12} for the conditional expressions X and X′ computed by expression (1).

Then, the correlation coefficient computation unit 13 computes a correlation coefficient R_{y12X} for the conditional expression X between the matrix Y1 of the first observed values and the matrix Y2 of the second observed values, based on expression (4) in the upper part of the right diagram of FIG. 7B. The correlation coefficient computation unit 13 computes a correlation coefficient R_{y12X′} for the conditional expression X′ between the matrix Y1 of the first observed values and the matrix Y2 of the second observed values, based on expression (4) in the lower part of the right diagram of FIG. 7B.

In a similar manner, the correlation coefficient computation unit 13 computes the correlation coefficient for the conditional expressions X and X′ between another observed value pair. This allows the correlation coefficient computation unit 13 to collectively compute the negative condition X′ for the conditional expression X, which in turn enables to halve the number of cycles involved in computing S_{y1} indicated by expression (2), S_{y2} indicated by expression (3), and S_{y12} indicated by expression (1) among the correlation coefficient operations.

Returning to FIG. 1, the determination unit 14 determines whether or not there are n or more observed value pairs whose correlation coefficients exceed the threshold value, for individual conditions used for filtering. Here mentioned n may be “1” or only has to be defined in advance. Then, if there are n or more observed value pairs whose correlation coefficients exceed the threshold value, the determination unit 14 saves the condition used for filtering.

[Flow of Correlation Coefficient Computation Process]

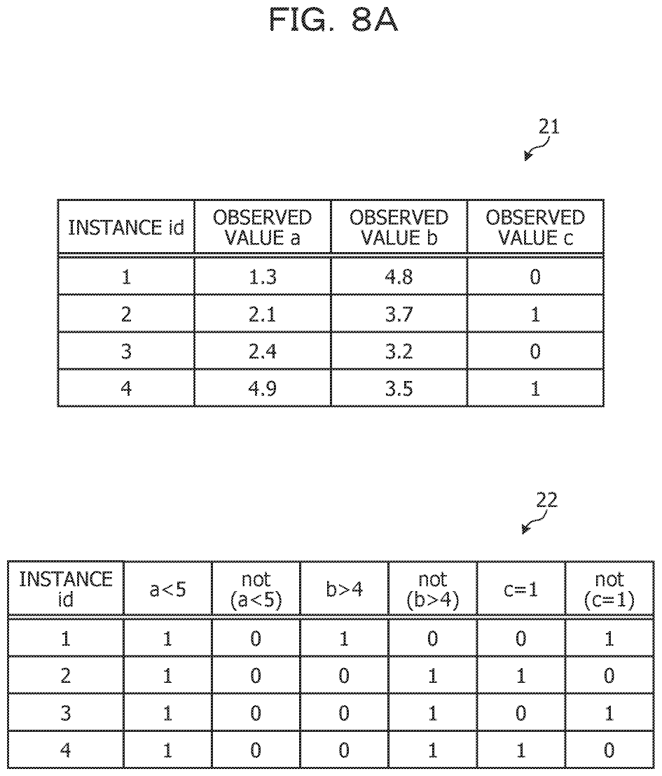

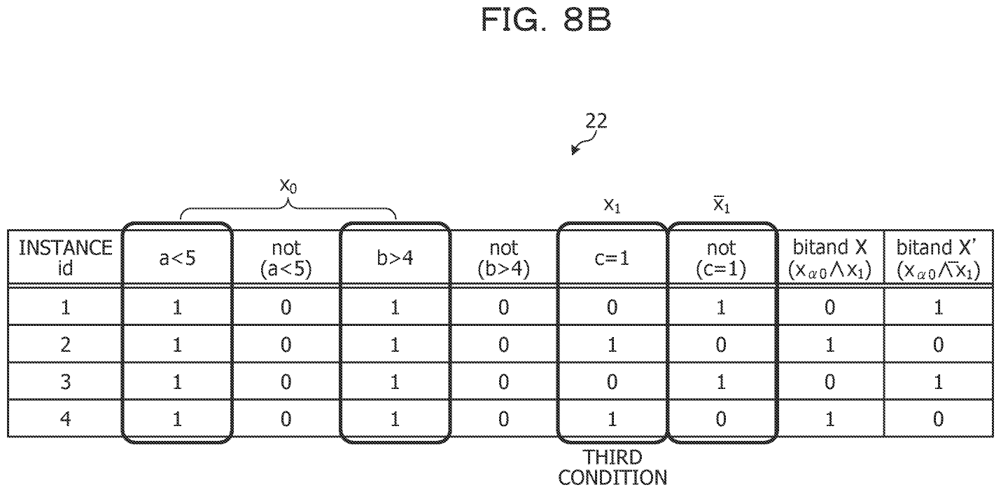

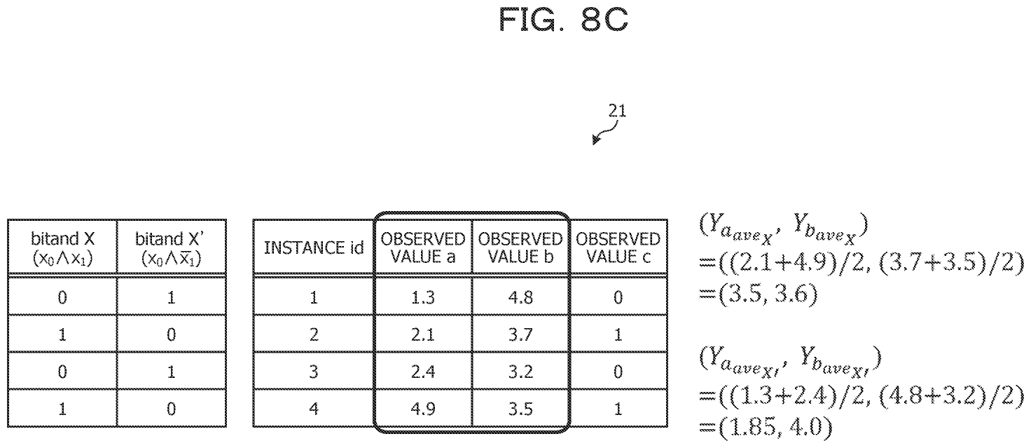

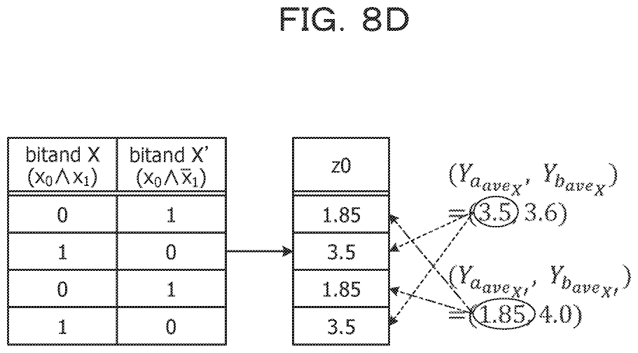

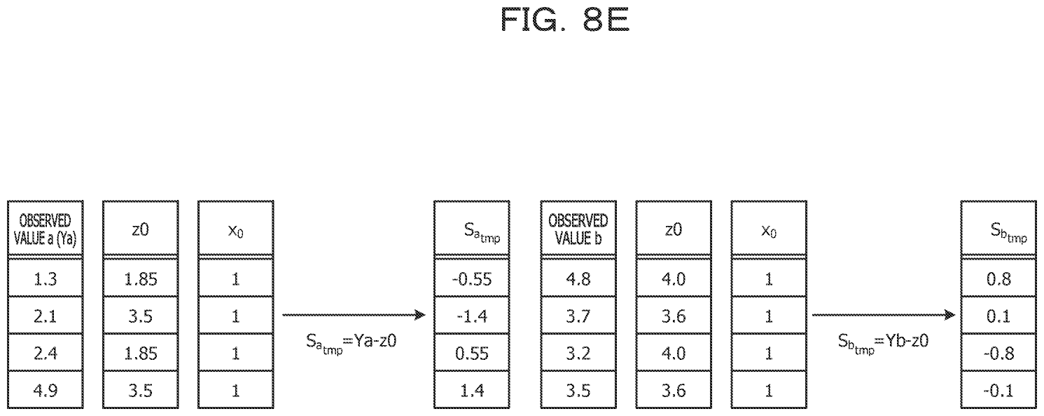

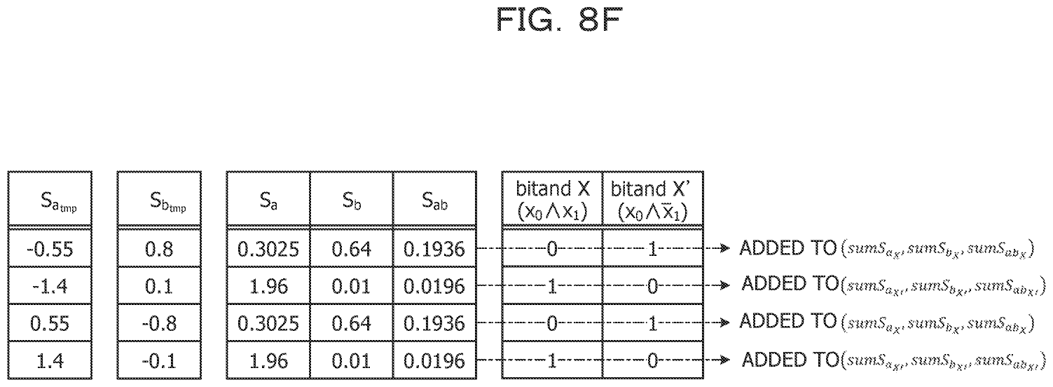

FIGS. 8A to 8F are diagrams illustrating an example of the flow of the correlation coefficient computation process according to the embodiment.

FIG. 8A represents the observed value list 21 and the condition list 22. The observed value list 21 stores the values of the observed values a, the values of the observed values b, and the values of the observed values c associated with the instances id. For example, the column-wise array of the observed values a, the column-wise array of the observed values b, and the column-wise array of the observed values c are stored. Then, the condition list 22 stores “0” or “1” corresponding to each condition in association with the instance id. The fact that the condition is not met is indicated by “0”, and the fact that the condition is met is indicated by “1”. In addition, the conditions included in the condition list 22 have paired not conditions.

The conditional expression is then generated from the condition list 22. In FIG. 8B, it is assumed that the conditional expression is generated by taking out three conditions from among all the conditions. Here, the conditional expression is “(a<5) and (b>4) and (c=1)” indicating the logical product of “a<5”, “b>4”, and “c=1”. This conditional expression is assumed as X. In addition, the conditional expression “(a<5) and (b>4) and not(c=1)” obtained by changing the third condition “c=1” to the negative condition is assumed as X′. Then, the conditional expression X is used to calculate bitand (logical product). The conditional expression X′ is used to calculate bitand (logical product). Note that, here, the bit string of x₀ “(a<5) and (b>4)”, which is a condition common to the conditional expressions X and X′, is given as “1111”.

As illustrated in FIG. 8C, the average value computation processing unit 11 selects a pair of observed values for which the correlation coefficients are to be determined. Here, it is assumed that a pair of the observed values a and b is selected. The average value computation processing unit 11 loads the bit string binarized by the conditional expression X into the predicate register. Then, the average value computation processing unit 11 masks the arithmetic logical units (ALUs) with the predicate register to compute an average value Ya_{aveX} of the observed values a. The average value computation processing unit 11 masks the arithmetic logical units (ALUs) with the predicate register to compute an average value Yb_{aveX} of the observed values b. Here, (Ya_{aveX}, Yb_{aveX}) is computed as (3.5 (=(2.1+4.9)×0.5), 3.6 (=(3.7+3.5)×0.5)).

Similarly, the average value computation processing unit 11 loads the bit string binarized by the conditional expression X′ into the predicate register. Then, the average value computation processing unit 11 masks the arithmetic logical units (ALUs) with the predicate register to compute an average value Ya_{aveX′} of the observed values a. The average value computation processing unit 11 masks the arithmetic logical units (ALUs) with the predicate register to compute an average value Yb_{aveX′} of the observed values b. Here, (Ya_{aveX′}, Yb_{aveX′}) is computed as (1.85 (=(1.3+2.4)×0.5), 4.0 (=(4.8+3.2)×0.5)).

As illustrated in FIG. 8D, the average value computation processing unit 11 loads the bit string “0101” binarized by the conditional expression X into the predicate register. Then, the average value computation processing unit 11 copies the average value Ya_{aveX} to a SIMD register z0 by masking with the predicate register. Here, the average value Ya_{aveX} “3.5” is copied to the second and fourth bits of the SIMD register z0.

In addition, the average value computation processing unit 11 loads the bit string “1010” binarized by the conditional expression X′ into the predicate register. Then, the average value computation processing unit 11 copies the average value Ya_{aveX′} to the SIMD register z0 by masking with the predicate register. Here, the average value Ya_{aveX′} “1.85” is copied to the first and third bits of the SIMD register z0.

As illustrated in FIG. 8E, the deviation computation processing unit 12 loads the bit string “1111” binarized by the condition x₀ common to the conditional expressions X and X′ into the predicate register. Then, the deviation computation processing unit 12 masks the arithmetic logical units (ALUs) with the predicate register to execute an operation of subtracting the SIMD register z0 from the matrix Ya obtained by taking out the values of the observed values a. Then, the deviation computation processing unit 12 loads the subtraction result into a SIMD register Sₐₜₘₚ. For example, the deviation computation processing unit 12 is allowed to compute “Ya−Yaₐᵥₑ” collectively for the conditional expressions X and X′.

Also for the observed value b, as in the case of the observed value a, the deviation computation processing unit 12 masks the arithmetic logical units (ALUs) with the predicate register to execute an operation of subtracting the SIMD register z0 from the matrix Yb obtained by taking out the values of the observed values b. Then, the deviation computation processing unit 12 loads the subtraction result into a SIMD register S_{btmp}. For example, the deviation computation processing unit 12 is allowed to compute “Yb−Ybₐᵥₑ” collectively for the conditional expressions X and X′.

As illustrated in FIG. 8F, the correlation coefficient computation unit 13 uses the predicate register to compute the square of the value sequence of the SIMD register Sₐₜₘₚ and loads the computed square into a SIMD register Sa. In this case, the bit string “1111” binarized by the condition x₀ common to the conditional expressions X and X′ is loaded into the predicate register. As a result, for the matrix Ya of the observed values a, the correlation coefficient computation unit 13 computes expression (2) collectively for the conditional expressions X and X′ to find Sa.

Also for the observed value b, as in the case of the observed value a, the correlation coefficient computation unit 13 uses the predicate register to compute the square of the value sequence of the SIMD register S_{btmp} and loads the computed square into the SIMD register S_{b}. In this case, the bit string “1111” binarized by the condition x₀ common to the conditional expressions X and X′ is loaded into the predicate register. As a result, for the matrix Yb of the observed values b, the correlation coefficient computation unit 13 computes expression (2) collectively for the conditional expressions X and X′ to find S_{b}.

In addition, the correlation coefficient computation unit 13 uses the predicate register to multiply the value sequence of the SIMD register Sₐₜₘₚ and the value sequence of the SIMD register S_{btmp} and loads the multiplied value sequence into a SIMD register S_{ab}. In this case, the bit string “1111” binarized by the condition x₀ common to the conditional expressions X and X′ is loaded into the predicate register. As a result, for the matrix Ya of the observed values a and the matrix Yb of the observed values b, the correlation coefficient computation unit 13 computes expression (1) collectively for the conditional expressions X and X′ to find S_{ab}.

Then, the correlation coefficient computation unit 13 loads the bit string “0101” binarized by the conditional expression X into the predicate register. The correlation coefficient computation unit 13 then masks Sa for the conditional expressions X and X′ with the predicate register and computes the sum (sum) of the unmasked elements to find “sumS_{aX}”. The correlation coefficient computation unit 13 masks S_{b} for the conditional expressions X and X′ with the predicate register and computes the sum (sum) of the unmasked elements to find “sumS_{bX}”. The correlation coefficient computation unit 13 masks S_{ab} for the conditional expressions X and X′ with the predicate register and computes the sum (sum) of the unmasked elements to find “sumS_{abX}”.

Then, the correlation coefficient computation unit 13 loads the bit string “1010” binarized by the conditional expression X′ into the predicate register. The correlation coefficient computation unit 13 then masks Sₐ for the conditional expressions X and X′ with the predicate register and computes the sum (sum) of the unmasked elements to find “sumS_{aX}”. The correlation coefficient computation unit 13 masks S_{b} for the conditional expressions X and X′ with the predicate register and computes the sum (sum) of the unmasked elements to find “sumS_{bX}”. The correlation coefficient computation unit 13 masks S_{ab} for the conditional expressions X and X′ with the predicate register and computes the sum (sum) of the unmasked elements to find “sumS_{abX′}”.

Then, the correlation coefficient computation unit 13 computes a correlation coefficient R_{yabX} between the observed values a and b for the conditional expression X, using (S_{aX}, S_{bX}, S_{abX}). The correlation coefficient computation unit 13 computes a correlation coefficient R_{yabX′} between the observed values a and b for the conditional expression X′, using (S_{aX′}, S_{bX′}, S_{abX′}).

[Flowchart of Correlation Coefficient Computation Process]

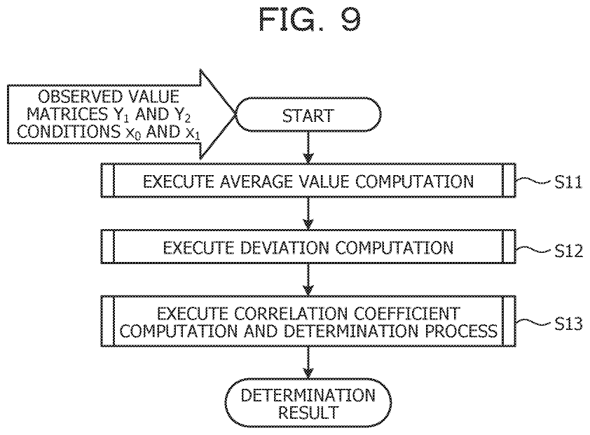

FIG. 9 is a diagram illustrating an example of the flowchart of the entire correlation coefficient computation process according to the embodiment. Note that the observed value list 21 and the condition list 22 have been stored in the storage unit 20. Then, it is assumed that the information processing device 1 has received observed value matrices Y₁ and Y₂ selected from the observed value list 21 and the conditions x₀ and x₁ selected from the condition list 22. The observed value matrices Y₁ and Y₂ are obtained by taking out matrices for two observed values from the observed value list 21.

The information processing device 1 uses the conditions x₀ and x₁ to execute the average value computation process for the observed value matrices Y₁ and Y₂ (operation S11). Note that the flowchart of the average value computation process will be described later.

The information processing device 1 uses the conditions x₀ and x₁ to execute the deviation computation process for the observed value matrices Y₁ and Y₂ (operation S12). Note that the flowchart of the deviation computation process will be described later.

The information processing device 1 uses the conditions x₀ and x₁ to execute a correlation coefficient computation and determination process for the observed value matrices Y₁ and Y₂ (operation S13). Note that the flowchart of the correlation coefficient computation and determination process will be described later. Then, the information processing device 1 ends a process for the correlation coefficient computation process.

[Flowchart of Average Value Computation Process]

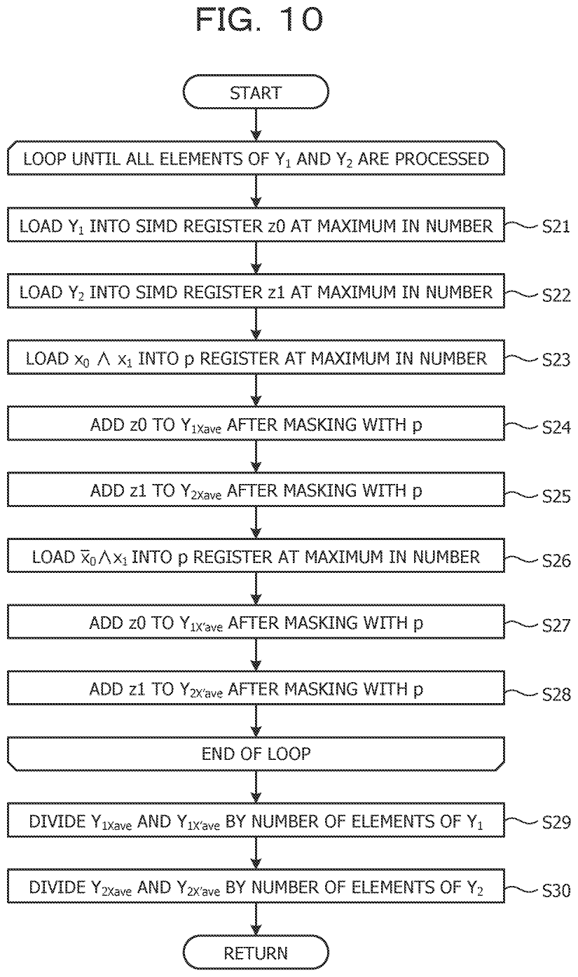

FIG. 10 is a diagram illustrating an example of the flowchart of the average value computation process according to the embodiment. Note that the p register indicated in the flowchart is a predicate register.

First, the average value computation processing unit 11 loops through operations S21 to S28 until all elements of the observed value matrices Y₁ and Y₂ are processed in order. The average value computation processing unit 11 loads the observed value matrix Y₁ into the SIMD register z0 at the maximum in number (operation S21). The average value computation processing unit 11 loads the observed value matrix Y₂ into a SIMD register z1 at the maximum in number (operation S22).

Then, the average value computation processing unit 11 loads the bit string corresponding to the conditional expression X “x₀∧x₁” into the p register at the maximum in number (operation S23). The average value computation processing unit 11 then adds the elements at the processing target positions of the SIMD register z0 to Y_{1Xave} after masking with the p register (operation S24). The average value computation processing unit 11 adds the elements at the same processing target positions of the SIMD register z1 to Y_{2Xave} after masking with the p register (operation S25).

Then, the average value computation processing unit 11 loads the bit string corresponding to the conditional expression X′ “x₀∧not(x₁)” into the p register at the maximum in number (operation S26). The average value computation processing unit 11 then adds the elements at the processing target positions of the SIMD register z0 to Y_{1X′ave} after masking with the p register (operation S27). The average value computation processing unit 11 adds the elements at the same processing target positions of the SIMD register z1 to Y_{2X′ave} after masking with the p register (operation S28).

Subsequently, after processing all the elements of the observed value matrices Y₁ and Y₂, the average value computation processing unit 11 divides Y_{1Xave} and Y_{1X′ave} by the number of elements of the observed value matrix Y₁ (operation S29). For example, the average value computation processing unit 11 calculates the average value Y_{1Xave} of the remaining elements after masking the elements of the observed value matrix Y₁ with the bit string corresponding to the conditional expression X. The average value computation processing unit 11 calculates the average value Y_{1X′ave} of the remaining elements after masking the elements of the observed value matrix Y₁ with the bit string corresponding to the conditional expression X′.

Additionally, the average value computation processing unit 11 divides Y_{2Xave} and Y_{2X′ave} by the number of elements of the observed value matrix Y₂ (operation S30). The average value computation processing unit 11 calculates the average value Y_{2Xave} of the remaining elements after masking the elements of the observed value matrix Y₂ with the bit string corresponding to the conditional expression X. The average value computation processing unit 11 calculates the average value Y_{2X′ave} of the remaining elements after masking the elements of the observed value matrix Y₂ with the bit string corresponding to the conditional expression X′.

Then, the average value computation processing unit 11 ends the average value computation process.

[Flowchart of Deviation Computation Process]

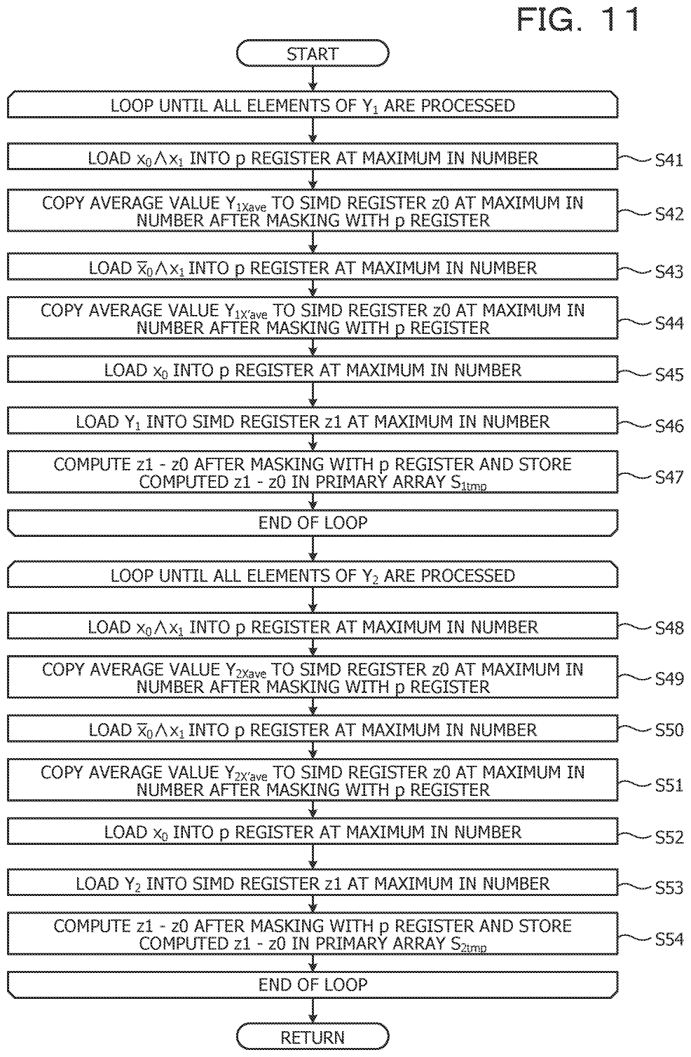

FIG. 11 is a diagram illustrating an example of the flowchart of the deviation computation process according to the embodiment.

First, the deviation computation processing unit 12 loops through operations S41 to S47 until all elements of the observed value matrix Y1 are processed in order. The deviation computation processing unit 12 loads the bit string corresponding to the conditional expression X “x₀∧x₁” into the p register at the maximum in number (operation S41). The deviation computation processing unit 12 copies the average value Y_{1Xave} to the SIMD register z0 at the maximum in number after masking with the p register (operation S42).

Then, the deviation computation processing unit 12 loads the bit string corresponding to the conditional expression X′ “x₀∧not(x₁)” into the p register at the maximum in number (operation S43). The deviation computation processing unit 12 copies the average value Y_{1X′ave} to the SIMD register z0 at the maximum in number after masking with the p register (operation S44).

Then, the deviation computation processing unit 12 loads the bit string corresponding to the condition x₀ common to the conditional expressions X and X′ into the p register at the maximum in number (operation S45). The deviation computation processing unit 12 loads the observed value matrix Y₁ into the SIMD register z1 at the maximum in number (operation S46). Then, after masking with the p register, the deviation computation processing unit 12 subtracts the SIMD register z0 from the SIMD register z1 and stores the subtracted SIMD register z1 in a primary array S₁ₜₘₚ (operation S47). For example, the deviation computation processing unit 12 computes the “observed value matrix Y₁−Y₁ₐᵥₑ” for the conditional expressions X and X′ and stores the computed “observed value matrix Y₁−Y₁ₐᵥₑ” in the primary array S₁ₜₘₚ.

Subsequently, after processing all the elements of the observed value matrix Y₁, the deviation computation processing unit 12 loops through operations S48 to S54 until all elements of the observed value matrix Y₂ are processed in order. The deviation computation processing unit 12 loads the bit string corresponding to the conditional expression X “x₀∧x₁” into the p register at the maximum in number (operation S48). The deviation computation processing unit 12 copies the average value Y_{2Xave} to the SIMD register z0 at the maximum in number after masking with the p register (operation S49).

Then, the deviation computation processing unit 12 loads the bit string corresponding to the conditional expression X′ “x₀∧not(x₁)” into the p register at the maximum in number (operation S50). The deviation computation processing unit 12 copies the average value Y_{2X′ave} to the SIMD register z0 at the maximum in number after masking with the p register (operation S51).

Then, the deviation computation processing unit 12 loads the bit string corresponding to the condition x₀ common to the conditional expressions X and X′ into the p register at the maximum in number (operation S52). The deviation computation processing unit 12 loads the observed value matrix Y₂ into the SIMD register z1 at the maximum in number (operation S53). Then, after masking with the p register, the deviation computation processing unit 12 subtracts the SIMD register z0 from the SIMD register z1 and stores the subtracted SIMD register z1 in a primary array S₂ₜₘₚ (operation S54). For example, the deviation computation processing unit 12 computes the “observed value matrix Y₂−Y₂ₐᵥₑ” for the conditional expressions X and X′ and stores the computed “observed value matrix Y₂−Y₂ₐᵥₑ” in the primary array S₂ₜₘₚ.

[Flowchart of Correlation Coefficient Computation and Determination Process]

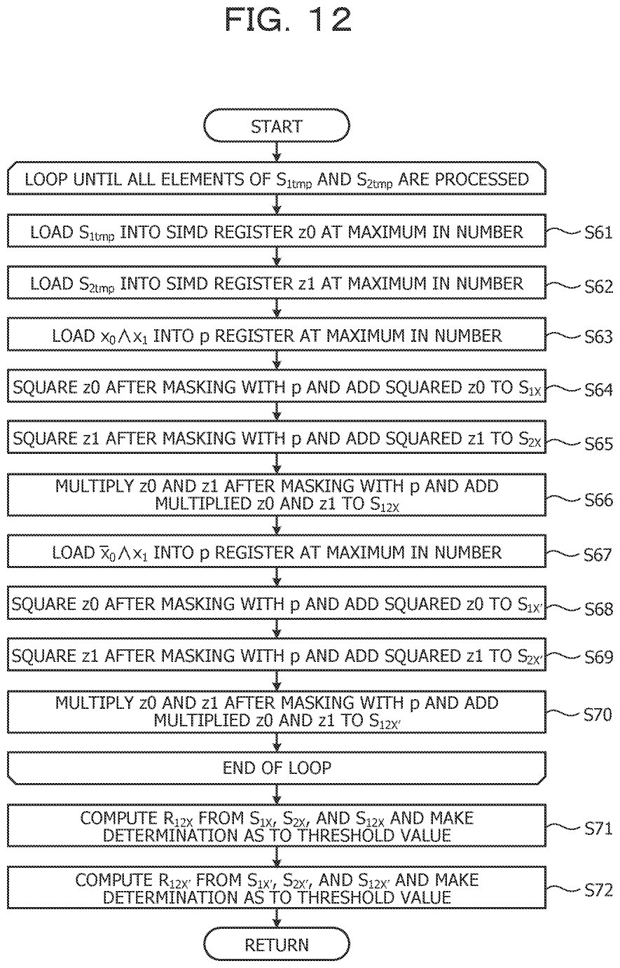

FIG. 12 is a diagram illustrating an example of the flowchart of the correlation coefficient computation and determination process according to the embodiment.

As illustrated in FIG. 12, the correlation coefficient computation unit 13 loops through operations S61 to S70 until all the elements of the primary array S₁ₜₘₚ storing the “observed value matrix Y₁−Y₁ₐᵥₑ” and the primary array S₂ₜₘₚ storing the “observed value matrix Y₂−Y₂ₐᵥₑ” are processed in order. The correlation coefficient computation unit 13 loads the primary array S₁ₜₘₚ storing the “observed value matrix Y₁−Y₁ₐᵥₑ” into the SIMD register z0 at the maximum in number (operation S61). The correlation coefficient computation unit 13 loads the primary array S₂ₜₘₚ storing the “observed value matrix Y₂−Y₂ₐᵥₑ” into the SIMD register z1 at the maximum in number (operation S62).

The correlation coefficient computation unit 13 loads the bit string corresponding to the conditional expression X “x₀∧x₁” into the p register at the maximum in number (operation S63). After masking with the p register, the correlation coefficient computation unit 13 squares the SIMD register z0 and adds the squared SIMD register z0 to Six (operation S64). For example, the correlation coefficient computation unit 13 computes “sum(observed value matrix Y₁−Y₁ₐᵥₑ)²” corresponding to the conditional expression X.

After masking with the p register, the correlation coefficient computation unit 13 squares the SIMD register z1 and adds the squared SIMD register z1 to S_{2X} (operation S65). For example, the correlation coefficient computation unit 13 computes “sum(observed value matrix Y₂−Y₂ₐᵥₑ)²” corresponding to the conditional expression X. After masking with the p register, the correlation coefficient computation unit 13 multiplies the SIMD registers z0 and z1 and adds the multiplied SIMD registers z0 and z1 to S_{12X} (operation S66). For example, the correlation coefficient computation unit 13 computes “sum{(observed value matrix Y₁−Y₁ₐᵥₑ)×(observed value matrix Y₂−Y₂ₐᵥₑ)}” corresponding to the conditional expression X.

The correlation coefficient computation unit 13 loads the bit string corresponding to the conditional expression X′ “x₀∧not(x₁)” into the p register at the maximum in number (operation S67). After masking with the p register, the correlation coefficient computation unit 13 squares the SIMD register z0 and adds the squared SIMD register z0 to S_{1X′} (operation S68). For example, the correlation coefficient computation unit 13 computes “sum(observed value matrix Y₁−Y₁ₐᵥₑ)²” corresponding to the conditional expression X′.

After masking with the p register, the correlation coefficient computation unit 13 squares the SIMD register z1 and adds the squared SIMD register z1 to S_{2X′} (operation S69). For example, the correlation coefficient computation unit 13 computes “sum(observed value matrix Y₂−Y₂ₐᵥₑ)²” corresponding to the conditional expression X′. After masking with the p register, the correlation coefficient computation unit 13 multiplies the SIMD registers z0 and z1 and adds the multiplied SIMD registers z0 and z1 to S_{12X′} (operation S70). For example, the correlation coefficient computation unit 13 computes “sum{(observed value matrix Y₁−Y₁ₐᵥₑ)×(observed value matrix Y₂−Y₂ₐᵥₑ)}” corresponding to the conditional expression X′.

Subsequently, after processing all the elements of the primary arrays S₁ₜₘₚ and S₂ₜₘₚ, the correlation coefficient computation unit 13 computes a correlation coefficient R_{12X} from S_{1X}, S_{2X}, and S_{12X} corresponding to the conditional expression X, and the determination unit 14 performs the determination process as to the threshold value (operation S71). For example, the determination unit 14 computes the correlation coefficient R_{12X} based on expression (1). Then, the determination unit 14 determines whether or not the correlation coefficient R_{12X} exceeds the threshold value and holds the determination result. In addition, the correlation coefficient computation unit 13 computes a correlation coefficient R_{12X′} from S_{1X′}, S_{2X′}, and S_{12X′} corresponding to the conditional expression X′, and the determination unit 14 performs the determination process as to the threshold value (operation S72). For example, the determination unit 14 computes the correlation coefficient R_{12X′} based on expression (1). Then, the determination unit 14 determines whether or not the correlation coefficient R_{12X′} exceeds the threshold value and holds the determination result.

Thereafter, the correlation coefficient computation unit 13 changes the pair of the observed value matrices Y1 and Y₂ and computes the correlation coefficients corresponding to the conditional expressions X and X′. Then, the determination unit 14 determines whether or not there are n, which is designated in advance, or more observed value pairs whose correlation coefficients exceed the threshold value and, when the determination condition is met, the conditional expression used for extraction is saved.

In this manner, the correlation coefficient computation unit 13 is allowed to perform computation of S_{12X}, S_{1X}, and S_{2X} corresponding to the condition X collectively with computation of S_{12X′}, S_{1X′}, and S_{2X′} corresponding to the condition X′ and accordingly, may compute the correlation coefficients for the conditions X and X′ efficiently. As a result, the correlation coefficient computation unit 13 may perform processes up to the determination of the conditional expression more quickly than in the prior art.

### Effects of Embodiments

According to the above embodiment, the information processing device 1 calculates a first average value of remaining elements after masking, with a first condition, first column data obtained by taking out values of a first attribute from tabular data in which the values of a plurality of attributes that each sample has are accumulated for each sample. The information processing device 1 calculates a second average value of the remaining elements after masking the first column data with a second condition that negates the first condition. The information processing device 1 loads the first column data into a first register. The information processing device 1 loads the values obtained by masking the first average value with the first condition and the values obtained by masking the second average value with the second condition, into a second register. The information processing device 1 uses arithmetic logical units with the first register and the second register as inputs, to perform first subtraction between a value sequence loaded into the first register and the value sequence loaded into the second register. The information processing device 1 performs second subtraction on second column data obtained by taking out the values of a second attribute different from the first attribute, by a method same as the method in the process of performing the first subtraction. Then, the information processing device 1 calculates correlation coefficients between the first column data and the second column data for the first condition and the second condition, using a first value sequence obtained by the first subtraction and a second value sequence obtained by the second subtraction. According to such a configuration, when locating a condition for extracting a sample group having a pair of correlated attributes, the information processing device 1 may efficiently compute the correlation coefficients between the pair of attributes for the first condition and the second condition that negates the first condition, by utilizing the arithmetic logical units. For example, the information processing device 1 is allowed to utilize the arithmetic logical units that have been inactive in individual condition operations, for the computation of the subtraction between the correlation coefficients of the pair of attributes for the first condition and the second condition, and may enable efficient computation by utilizing the arithmetic logical units. As a result, the information processing device 1 may improve the CPU utilization rate.

In addition, according to the above embodiment, the information processing device 1 loads the first value sequence into the first register and the second register, and uses the arithmetic logical units with the first register and the second register as inputs to calculate first computation of squaring the first value sequence. The information processing device 1 loads the second value sequence into the first register and the second register and uses the arithmetic logical units with the first register and the second register as inputs to calculate second computation of squaring the second value sequence. The information processing device 1 loads the first value sequence into the first register, loads the second value sequence into the second register, and uses the arithmetic logical units with the first register and the second register as inputs to calculate third computation of multiplying the first value sequence and the second value sequence. Then, the information processing device 1 calculates the correlation coefficients between the first column data and the second column data for the first condition and the second condition, using the first computation result, the second computation result, and the third computation result. According to such a configuration, the information processing device 1 is allowed to utilize the arithmetic logical units that have been inactive in individual condition operations, for the computation of multiplying the subtraction results for the correlation coefficients of the pair of attributes for the first condition and the second condition, and may enable efficient computation by utilizing the arithmetic logical units.

In addition, according to the above embodiment, the information processing device 1 uses the predicate register to load the values obtained by copying the first average value while masking with the first condition, and the values obtained by copying the second average value while masking with the second condition, into the second register. According to such a configuration, the information processing device 1 may load the respective average values into the same register, by separately masking with the first condition and the second condition, by using the predicate register.

In addition, according to the above embodiment, the information processing device 1 further uses the predicate register to calculate value sequences by masking each of the first computation result, the second computation result, and the third computation result with the first condition, and uses each of the calculated value sequences to calculate the correlation coefficients between the first column data and the second column data for the first condition. Then, the information processing device 1 uses the predicate register to calculate value sequences by masking each of the first computation result, the second computation result, and the third computation result with the second condition, and uses each of the calculated value sequences to calculate the correlation coefficients between the first column data and the second column data for the second condition. According to such a configuration, the information processing device 1 may break up the computation results by separately masking with the first condition and the second condition, by using the predicate register. As a result, the information processing device 1 may efficiently compute the correlation coefficients of the pair of attributes for the first condition and the second condition.

Note that each illustrated component of the information processing device 1 does not necessarily have to be physically configured as illustrated in the drawings. For example, specific forms of distribution and integration of the information processing device 1 are not limited to the illustrated ones, and the whole or a part of the information processing device 1 may be configured by being functionally or physically distributed and integrated in any units according to various loads, use states, or the like. In addition, the storage unit 20 may be connected through a network as an external device of the information processing device 1.

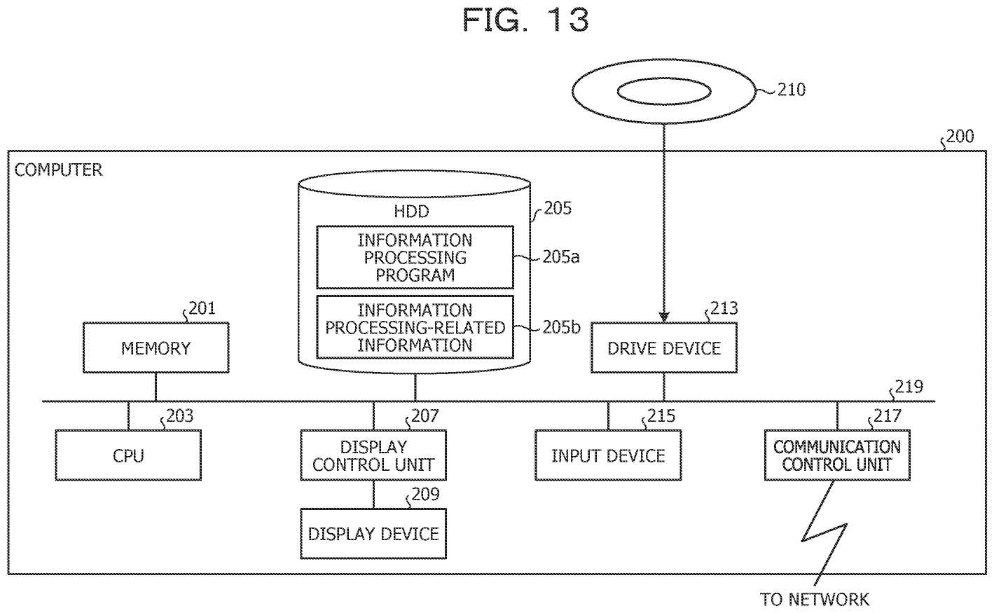

Furthermore, various types of processing described in the above embodiment may be implemented by a computer such as a personal computer or a workstation executing programs prepared in advance. Thus, in the following, an example of the computer that executes an information processing program that implements functions similar to the functions of the information processing device 1 illustrated in FIG. 1 will be described. Here, the information processing program that implements functions similar to the functions of the information processing device 1 will be described as an example. FIG. 13 is a diagram illustrating an example of the computer that executes the information processing program.

As illustrated in FIG. 13, a computer 200 includes a CPU 203 that executes various arithmetic processes, an input device 215 that receives data input from a user, and a display control unit 207 that controls a display device 209. In addition, the computer 200 includes a drive device 213 that reads a program and the like from a storage medium, and a communication control unit 217 that exchanges data with another computer via a network. The computer 200 further includes a memory 201 that temporarily stores various types of information, and a hard disk drive (HDD) 205. Then, the memory 201, the CPU 203, the HDD 205, the display control unit 207, the drive device 213, the input device 215, and the communication control unit 217 are connected by a bus 219.

The drive device 213 is a device for a removable disk 210, for example. The HDD 205 stores an information processing program 205a and information processing-related information 205b.

The CPU 203 reads the information processing program 205a to load the read information processing program 205a into the memory 201 and executes the loaded information processing program 205a as a process. Such a process corresponds to the respective functional units of the information processing device 1. The information processing-related information 205b corresponds to the observed value list 21 and the condition list 22. Then, for example, the removable disk 210 stores each piece of information such as the information processing program 205a.

Note that the information processing program 205a may not necessarily be stored in the HDD 205 from the beginning. For example, the program is stored in a “portable physical medium” to be inserted into the computer 200, such as a flexible disk (FD), a compact disk read only memory (CD-ROM), a digital versatile disk (DVD), a magneto-optical disk, or an integrated circuit (IC) card. Then, the computer 200 may read the information processing program 205a from these media to execute the read information processing program 205a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a correlation coefficient computation program for causing a computer to execute a process, the process comprising:
obtaining a first average value of remaining elements after masking, with a first condition, first column data obtained by taking out values of a first attribute from tabular data in which values of a plurality of attributes that each sample includes are accumulated for each sample;
obtaining a second average value of the remaining elements after masking the first column data with a second condition that negates the first condition;
loading the first column data into a first register;
loading values obtained by masking the first average value with the first condition and values obtained by masking the second average value with the second condition, into a second register;
obtaining a first value sequence by performing first subtraction between value sequences loaded into the first register and value sequences loaded into the second register on the first column data;
obtaining a third average value of remaining elements after masking, with a first condition, second column data obtained by taking out values of a second attribute from tabular data in which values of a plurality of attributes that each sample includes are accumulated for each sample;
obtaining a fourth average value of the remaining elements after masking the second column data with the second condition that negates the first condition;
loading the second column data into a first register;
loading values obtained by masking the third average value with the first condition and values obtained by masking the forth average value with the second condition, into a second register;
obtaining a second value sequence by performing second subtraction between value sequences loaded into the first register and value sequences loaded into the second register on the second column data; and
obtaining correlation coefficients between the first column data and the second column data for the first condition and the second condition, based on the first value sequence and the second value sequence, by using arithmetic logical units with the first register and the second register as inputs.

2. The non-transitory computer-readable recording medium according to claim 1, wherein the obtaining correlation coefficients includes
loading the first value sequence into the first register and the second register, and obtaining first computation of squaring the first value sequence,
loading the second value sequence into the first register and the second register, and obtaining second computation of squaring the second value sequence,
loading the first value sequence into the first register, loading the second value sequence into the second register, and obtaining third computation of multiplying the first value sequence and the second value sequence, and
obtaining the correlation coefficients between the first column data and the second column data for the first condition and the second condition, by using computation results of the first computation, the second computation, and the third computation.

3. The non-transitory computer-readable recording medium according to claim 1, wherein the loading into the second register includes loading values obtained by copying the first average value while masking with the first condition, and values obtained by copying the second average value while masking with the second condition, into the second register, by using a predicate register.

4. The non-transitory computer-readable recording medium according to claim 2, wherein the obtaining the correlation coefficients includes
obtaining value sequences by masking each of the computation results of the first computation, the second computation, and the third computation with the first condition by using the predicate register, and obtaining the correlation coefficients between the first column data and the second column data for the first condition, based on each of the obtained value sequences;
obtaining the value sequences by masking each of the computation results of the first computation, the second computation, and the third computation with the second condition by using the predicate register, and obtaining the correlation coefficients between the first column data and the second column data for the second condition, based on each of the obtained value sequences.

5. An information processing device comprising:
a memory; and
a processor coupled to the memory and configured to:
obtain a first average value of remaining elements after masking, with a first condition, first column data obtained by taking out values of a first attribute from tabular data in which values of a plurality of attributes that each sample includes are accumulated for each sample;
obtain a second average value of the remaining elements after masking the first column data with a second condition that negates the first condition;
load the first column data into a first register;
load values obtained by masking the first average value with the first condition and values obtained by masking the second average value with the second condition, into a second register;
obtain a first value sequence by performing first subtraction between value sequences loaded into the first register and value sequences loaded into the second register on the first column data;
obtain a third average value of remaining elements after masking, with a first condition, second column data obtained by taking out values of a second attribute from tabular data in which values of a plurality of attributes that each sample includes are accumulated for each sample;
obtain a fourth average value of the remaining elements after masking the second column data with the second condition that negates the first condition;
load the second column data into a first register;
load values obtained by masking the third average value with the first condition and values obtained by masking the forth average value with the second condition, into a second register;
obtain a second value sequence by performing second subtraction between value sequences loaded into the first register and value sequences loaded into the second register on the second column data; and
obtain correlation coefficients between the first column data and the second column data for the first condition and the second condition, based on the first value sequence and the second value sequence, by using arithmetic logical units with the first register and the second register as inputs.

6. A correlation coefficient computation method causing a computer to execute a process, the process comprising:
obtaining a first average value of remaining elements after masking, with a first condition, first column data obtained by taking out values of a first attribute from tabular data in which values of a plurality of attributes that each sample includes are accumulated for each sample;
obtaining a second average value of the remaining elements after masking the first column data with a second condition that negates the first condition;
loading the first column data into a first register;
loading values obtained by masking the first average value with the first condition and values obtained by masking the second average value with the second condition, into a second register;
obtaining a first value sequence by performing first subtraction between value sequences loaded into the first register and value sequences loaded into the second register on the first column data;
obtaining a third average value of remaining elements after masking, with a first condition, second column data obtained by taking out values of a second attribute from tabular data in which values of a plurality of attributes that each sample includes are accumulated for each sample;
obtaining a fourth average value of the remaining elements after masking the second column data with the second condition that negates the first condition;
loading the second column data into a first register;
loading values obtained by masking the third average value with the first condition and values obtained by masking the forth average value with the second condition, into a second register;
obtaining a second value sequence by performing second subtraction between value sequences loaded into the first register and value sequences loaded into the second register on the second column data; and
obtaining correlation coefficients between the first column data and the second column data for the first condition and the second condition, based on the first value sequence and the second value sequence, by using arithmetic logical units with the first register and the second register as inputs.
